(19) United States
(12) Patent Application Publication
(10) Pub. No.: US 2008/0270576 A1
(43) Pub. Date: Oct. 30, 2008

(54) APPARATUS AND METHODS FOR REDUCING DATA TRANSMISSION IN WIRELESS CLIENT-SERVER NAVIGATION SYSTEMS

(76) Inventor: Ian Cummings, Ypsilanti, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/116,714

(22) Filed: May 7, 2008

Related U.S. Application Data
(63) Continuation-in-part of application No. 11/697,977, filed on Apr. 9, 2007.
(60) Provisional application No. 60/916,399, filed on May 7, 2007.

(51) Int. Cl. G06F 15/16

(52) U.S. Cl. 709/219

(57) ABSTRACT

Methods and apparatus reduce data transmission in a wireless client-server navigation system. Data is transmitted from a mobile client to a central server explicitly or implicitly requesting the transmission of map data from the central server. At the same time or previously, the mobile client forwards to the central server, a summary of map data already present at the mobile client. The central server compares the received request to the map data already present at the mobile client based upon the information received from the mobile client, and if there is overlap, the central server downloads the map data requested by the client, but excludes map data determined by the server to be already present in the client based on the previously transmitted summary information, thereby reducing data transmission requirements. The summary of map data present in the client may be transmitted to the central server in a reduced-data format. The reduced-data format may comprise designators associated with regions such as tiles into which a map has been partitioned. System-level aspects are additionally disclosed.

### REFERENCE TO RELATED APPLICATIONS

This application is a continuation-in-part of U.S. patent application Ser. No. 11/697,977, filed Apr. 9, 2007. This application also claims priority to U.S. Provisional Patent Application Ser. No. 60/916,399, filed May 7, 2007. The entire content of each application is incorporated herein by reference.

### FIELD OF THE INVENTION

This invention relates generally to navigation systems and, in particular, to apparatus and methods for reducing data transmission in wireless client-server environments.

### BACKGROUND OF THE INVENTION

The engineering and business requirements of navigation by wireless client-server (WCS) navigators, in which route searches and map generation are performed at a central location then transmitted to mobile units, differ somewhat from those of standard standalone navigators. One major difference is that for WCS navigators, data transmission costs are a large part of the ongoing cost of operating the navigation system. In order to economically provide WCS navigation, it is important to minimize the amount of data transmitted while still meeting customers' navigation needs.

### SUMMARY OF THE INVENTION

This invention is directed to methods and apparatus for reducing data transmission in a wireless client-server navigation system of the type wherein mobile clients request and receive guidance from a central server accessing databases of geographical information. According to one preferred method, data is transmitted from a mobile client to a central server explicitly or implicitly requesting the transmission of map data from the central server. At the same time or previously, the mobile client forwards to the central server, a summary of map data already present at the mobile client. The central server compares the received request to the map data already present at the mobile client based upon the information received from the mobile client, and if there is overlap, the central server downloads the map data requested by the client, but excludes map data determined by the server to be already present in the client based on the previously transmitted summary information, thereby reducing data transmission requirements.

The summary of map data present in the client may be transmitted to the central server in a reduced-data format. The reduced-data format may comprise designators associated with regions such as tiles into which a map has been partitioned. The reduced data format may further comprise designators associated with tiles into which the map has been partitioned and offsets from the designator each of which uniquely specifies a tile. The offsets may also be represented by a data format less data-intensive than the format used to represent the designators. The reduced data format also includes representations of blocks of data, and the blocks may also be represented in a format less data intensive than the format used to represent the designators. The server may further exclude data from being sent to the client based on one or more geographical criteria, such as a distance from a location or route.

A wireless client-server navigation system with reduced data transmission requirements according to the invention comprises a central server accessing databases of geographical information and a mobile client operative to request and receive guidance from the central server, the mobile client including a memory for storing map data. A processor at the central server is operative to compare a request for map data from the mobile client to a summary from the client regarding map data already stored at the mobile client so that the central server need only download the differences in the map data, if any, to the mobile client.

### BRIEF DESCRIPTION OF THE DRAWINGS

FIG. 1 shows a tile method according to the present invention;

FIG. 2 shows a tile method with a map divided into tiles with reference points;

FIG. 3 shows a tile method with Point A being represented as an offset from a reference point;

FIG. 4 shows a fitted curve embodiment as a true geographic feature;

FIG. 5 shows a fitted curve as a line approximation to the geographic feature;

FIG. 6 shows a curve constructed to approximate a route;

FIG. 7A is a chart that shows data to be transmitted for the line approximation of FIG. 6.

FIG. 7B is a chart that shows data to be transmitted for the curve approximation of FIG. 6;

FIG. 8 shows a fitted curve as a geographic feature shown to a user;

FIG. 9 shows a point removal embodiment according to the invention;

FIG. 10 shows points selected for removal;

FIG. 11 shows a point removal example as an approximation of a geographic feature;

FIG. 12 shows a point removal example generating a measure of the accuracy of the approximation;

FIG. 13 shows a graphical portrayal of a method to reduce map data transmission by sending information regarding data present at the client; and

FIG. 14 illustrates reducing the amount of data transmitted by describing blocks of data.

### DETAILED DESCRIPTION OF THE INVENTION

The various embodiments described herein are intended to be used with a wireless client-server (WCS) navigation system. Such a system provides guidance in the form of maps, routes, and/or instructions, and

1) which has mobile clients used for requesting and receiving guidance,

2) which has a central server that houses databases of geographical information, and which generates guidance, and

3) wherein data is transmitted between the mobile clients and central server.

In existing navigation systems, geographic data is often generated and stored using highly accurate but data-intensive means. For example, in the commonly used shapefile format depicted in FIG. 1, each point 102 is stored as an (x,y) coordinate using the double float data format, requiring a total of 16 bytes.

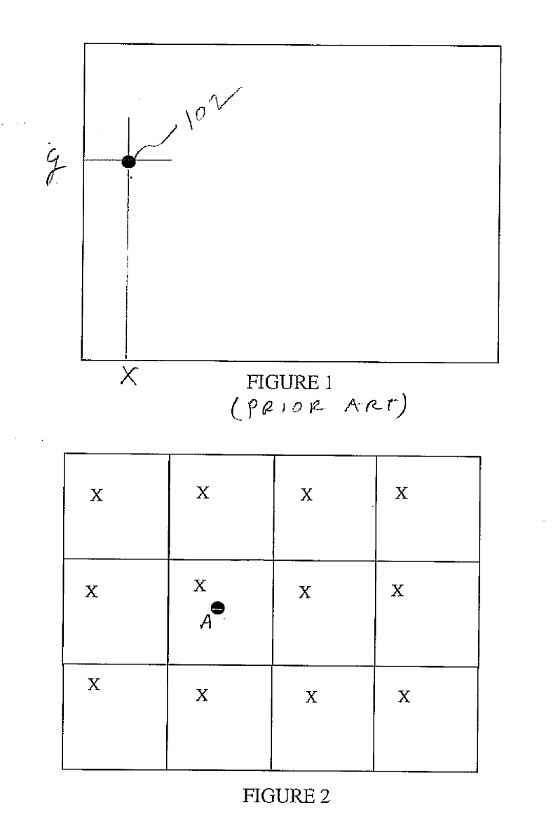

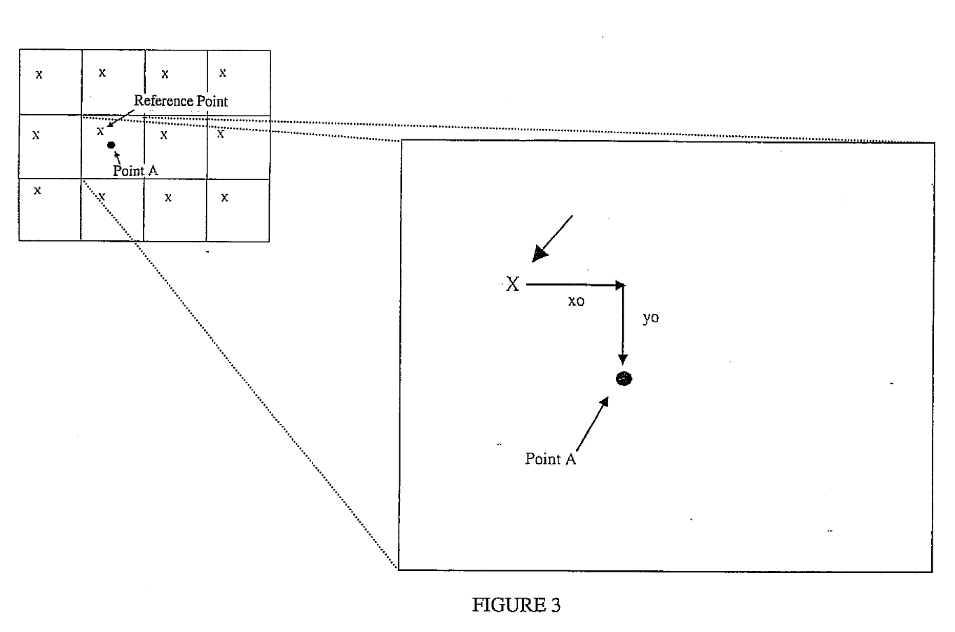

The tile method according to this invention uses a less data intensive method to preserve required accuracy while minimizing the amount of data transmitted. In the tile method, depicted in FIG. 2, a map is divided into a set of tiles. The tiles are generally of equal size, although this is not necessary. Each tile is assigned a reference point X, and the coordinates of each point A within each tile are then represented as a offset (xo, yo in FIG. 3) from the reference point. The tile method may be applied when a request for a map is received, or a tiled map may be generated then used for future map requests.

As an example of how this could provide benefits in data transmission, suppose points in a map are stored in shapefile format, requiring 16 bytes to represent each point. The map is divided up into tiles measuring one mile east-west by one mile north-south. Further suppose that it has been determined that users of the navigator require no greater resolution than 25 feet; meaning that if a feature is within 25 feet of where their navigator says, then it's good enough for them. A reference point is selected within the tile, and all points within the tile are represented as an offset from the reference location. In a one square mile tile, all locations can be measured as an offset from a reference point to within 25 feet by a set of data including x and y coordinates in 8 bit integer format, requiring 2 bytes total for each point, since 5280 feet/mile divided by 2̂8 is 20.625 feet.

In this example, 16 additional bytes of data are required to represent the reference point of each tile, but for each point within the tile, 14 bytes are saved. Thus if there is on average more than one point per tile, an overall reduction in data transmission can be achieved with the specific approach of this example.

The tile method also has the advantage of dividing data to be transmitted into discrete, easily manipulated units of data.

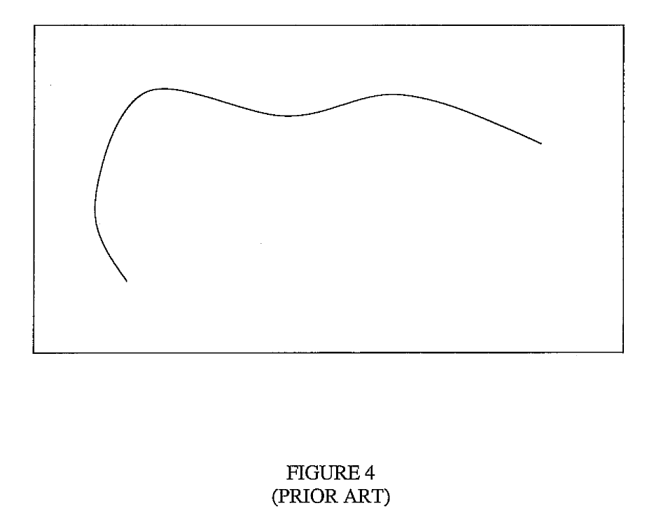

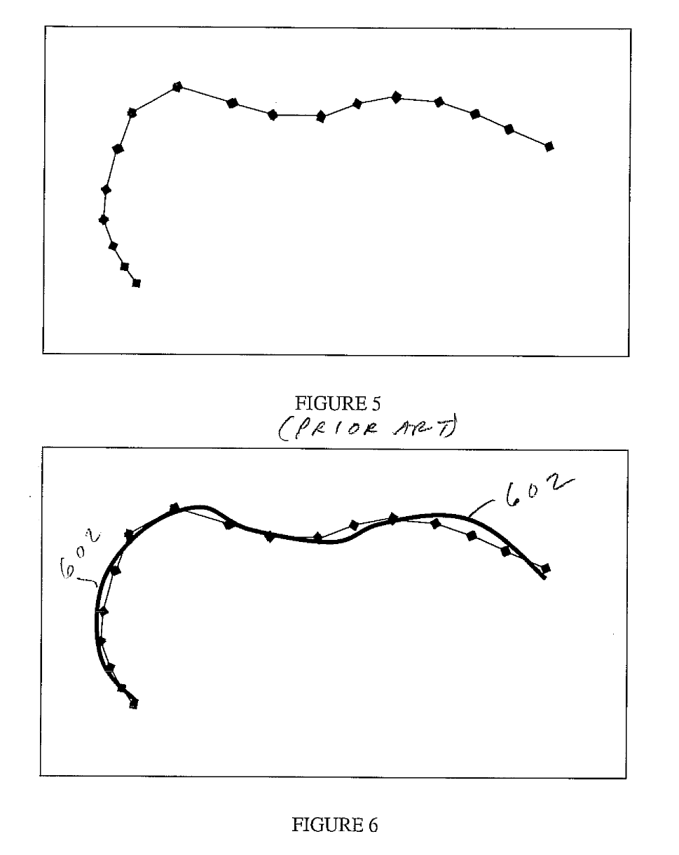

Many standard representations of geographical information are limited to the use of straight lines. When a curve such as that shown in FIG. 4 must be approximated, a large number of straight lines are used instead, as shown in FIG. 5. While this improves the accuracy of the map, in WCS navigators it also greatly increases the amount of map data that must be transmitted.

According to this invention, instead of transmitting all of the points of straight lines representing a curve, the navigation system transmits information from which a curve can be constructed that approximates the lines provided in the geographical information.

In the first step of this method, a curve such as 602 shown in FIG. 6 is generated that approximates lines provided in geographical information. A large number of curve construction methods are possible, including Bezier curves, other splines, polynomial curves, and fractals. This method is not intended to be limited to any particular method of generating curves. A measure of accuracy of the generated curve is defined and used to judge the suitability of the curve.

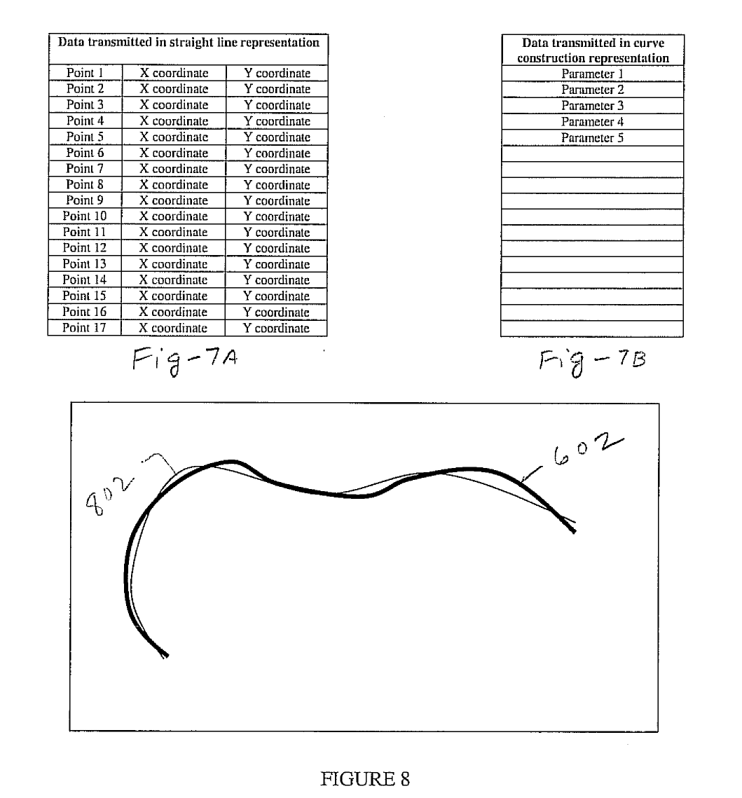

The information representing the curve is then transmitted from the server to the client. The information may be a set of points along the curve, or it may be another arbitrary representation. The type of curve and information about how it is to be reconstructed may also be transmitted, or it may have been previously provided to the client. The client receives the information and from it constructs a graphical representation of the curve for use of the customer. FIG. 7A is a chart that shows data to be transmitted for line approximation, versus the curve approximation in FIG. 7B. FIG. 8 shows the approximation 602 versus the actual geographic feature 802. Again, information representing the curve may be generated at the time a user requests map information or it may be generated at an earlier time and stored for future use.

### Point Removal Embodiment

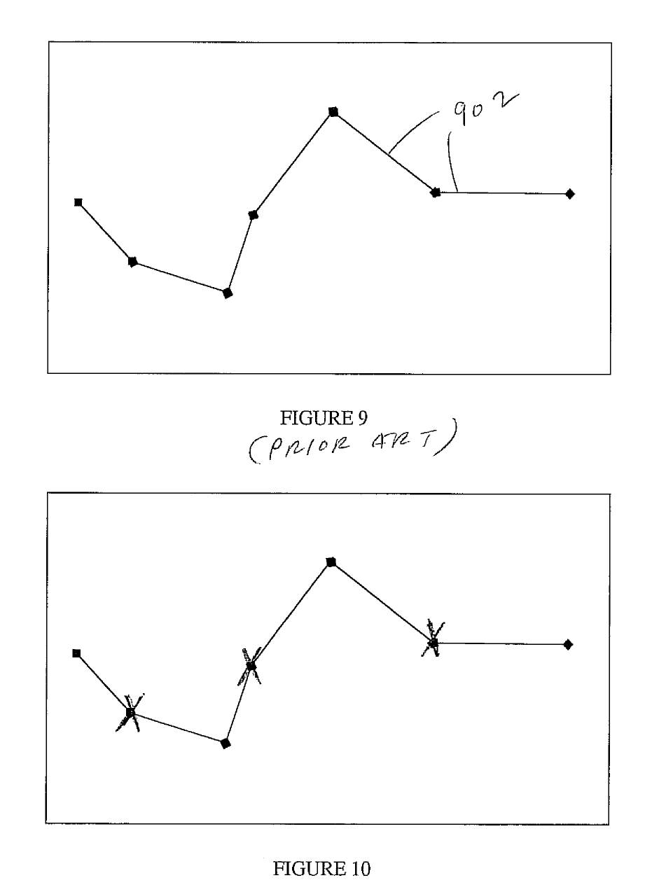

Many standard representations of geographical information are limited to the use of straight lines. When a curve must be approximated, a large number of straight lines 902 are used instead, as shown in FIG. 9. While this improves the accuracy of the map, in WCS navigators it also greatly increases the amount of map data that must be transmitted.

Many customers do not require the full accuracy provided by straight line approximations, particularly when maps are displayed that show large areas. For this reason it is useful to remove points of the representation if geographical data.

In this method:

1) A set of line segments representing a geographical feature is considered.

2) One or more points defining the line segments are identified for removal (the Xs in FIG. 10).

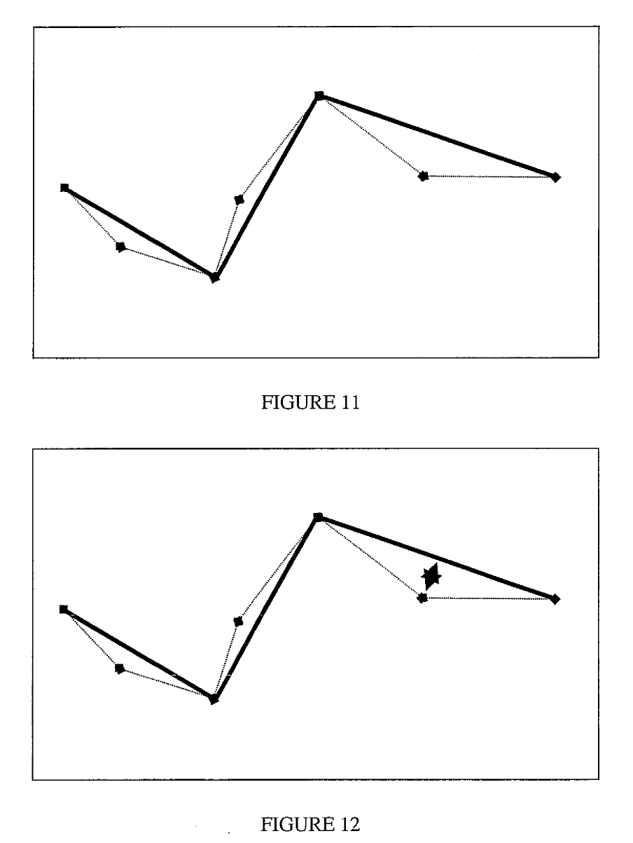

3) A new set of line segments is constructed using the remaining points, which approximates the original set of line segments FIG. 11).

4) A measure is generated of the nearness of the new set of line segments to the old set of line segments.

5) The measure is compared to a standard, and if the standard is met or exceeded, then the new set of line segments is used rather than the old set. Note that the standard may vary depending on map scale, user preferences, or other criteria. In FIG. 12, for example, the star-shaped symbol is used to show a relatively large deviation from actual which may not conform to a given standard.

6) The points of the new line segments are sent from the server to the client

7) A graphical representation of the new line segments are constructed by the client,

This method may be applied when a user requests a map, or various approximate maps may be generated and later used upon user request.

### Data Compression Embodiment

In order to reduce the amount of data sent with a WCS navigator, a variety of data compression algorithms may be used. Common examples of such algorithms include the Lempel-Ziv algorithm, the DEFLATE algorithm, the Lempel-Ziv-Welch algorithm, and LZ-Renau algorithm, although this method is not intended to be limited to these particular algorithms. The data compression method is to use a data compression algorithm to reduce the amount of data transmitted in a WCS navigator.

### Exclusion of Map Data Already Present at the Client

Data transmission of map data can be further reduced by the server refraining from sending data already present in the client. Since delay in a wireless client-server navigator is undesirable, a description of the map data in the client should be sent at the same time as the request provoking provision of map data by the server. This is an improvement over methods of previous art in which the client sends a request provoking provision of map data first, then the server sends a description of the map data needed to satisfy the client, then the client sends a description of which of the map described by the server are not present at the client, and then the server sends the necessary map data. The methods of the prior art can in certain circumstances increase the amount of time required for the process. During this increased time the mobile client may move out of wireless coverage which would cause the process to fail. Furthermore, data reduction methods are also applied to the data sent from the client to the server describing the map data present in the client.

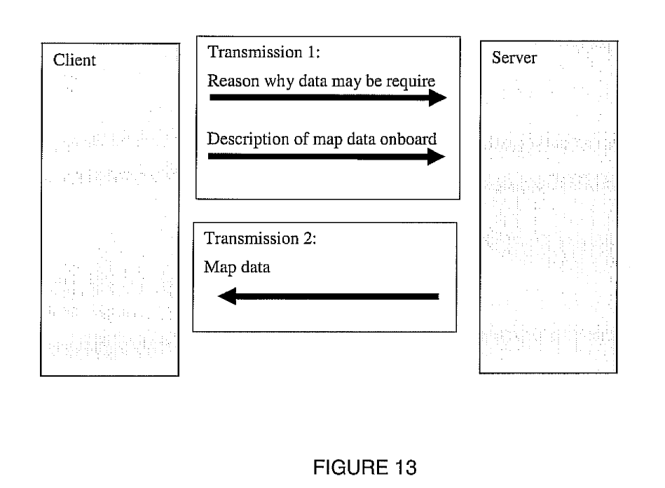

As depicted in FIG. 13, a mobile client has determined that it may require map data from the server. As examples, this may be because it is requesting a route from the server, or it may be because the mobile client has moved. The mobile client transmits to the server information regarding why it may need new map data, such as, for example, a routing request, and information describing the map data already held in the mobile client's onboard database. The server then determines from the information it has received and its own databases, computations, and algorithms whether the client requires map data not currently present in the client. If the client does require additional map data, the server then transmits the needed map data to the mobile client.

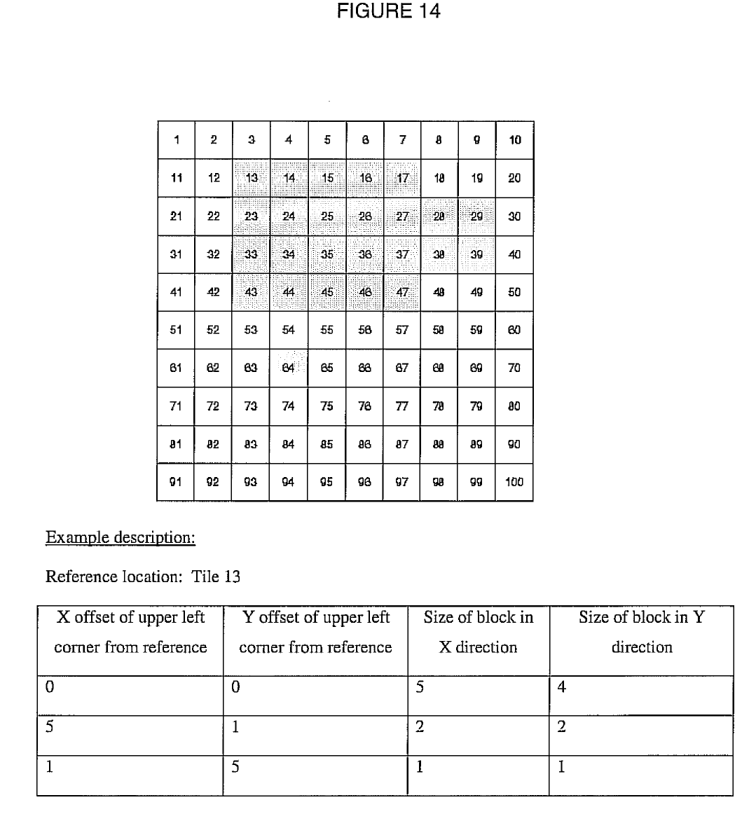

The data sent by the client to the server describing map data present in the client may be sent in a data-reduced form. In one data-reduced form the map data is divided into tiles and a unique designator is assigned to each tile. The designators are then transmitted to the server rather than actual map data. Another data reduced form is similar to the first except that only a single designator is transmitted and other tiles in the onboard database are represented as offsets from the single transmitted designator. As in the Tiling Embodiment, the offsets may be represented by a less precise data form than the designator. A third data reduced form is similar to the second except that descriptions of blocks of tiles are transmitted. As an example the mobile client may transmit to the server that it has onboard map data for tile 51,623 and all tiles in a rectangle extending 30 tiles east and 20 tiles south of tile 51,623. The data reduced forms are illustrated in FIG. 14.

The mobile client may limit the data transmitted regarding map data onboard to map data relevant to the reason for which it may need new map data. For example, if the mobile client is requesting a route to a location 10 miles distant, it may exclude from transmission information regarding map data onboard that is more than twenty miles from both its current location and the destination.

I claim:

1. A method of reducing the amount of data transmitted in a wireless client-server navigation system of the type wherein mobile clients request and receive guidance from a central server accessing databases of geographical information, the method comprising the steps of:
transmitting data from a mobile client to a central server explicitly or implicitly requesting the transmission of map data from the central server;
transmitting, from the mobile client to the central server, a summary of map data already present at the mobile client;
comparing, at the central server, the requested map data to the map data already present at the mobile client; and
transmitting, from the central server to the mobile client, map data requested by the client, but excluding map data determined by the server to be already present in the client based on the previously transmitted summary information.

2. The method of claim 1, wherein the summary of map data present in the client is transmitted to the central server in a reduced-data format.

3. The method of claim 2, wherein the reduced-data format comprises designators associated with regions into which a map has been partitioned.

4. The method of claim 3, wherein the regions are tiles.

5. The method of claim 2, wherein the reduced data format comprises:
designators associated with tiles into which the map has been partitioned; and
offsets from said designator each of which said offsets uniquely specifies a tile.

6. The method of claim 5, wherein the offsets are represented by a data format less data-intensive than the format used to represent the designators.

7. The method of claim 5, wherein the reduced data format also includes representations of blocks of data.

8. The method of claim 7, wherein the blocks of data are represented in a format less data intensive than the format used to represent the designators.

9. The method of claim 1, wherein the server excludes data from being sent to the client based on one or more geographical criteria.

10. The method of claim 9, wherein the criteria includes a distance from a location or route.

11. The method of claim 1, wherein the data from the mobile client requesting the transmission of map data and a summary of map data already present at the mobile client are transmitted to the central server at substantially the same time.

12. A wireless client-server navigation system with reduced data transmission requirements, comprising:
a central server accessing databases of geographical information;
a mobile client operative to request and receive guidance from the central server, the mobile client including a memory for storing map data;
a processor at the central server operative to compare a request for map data from the mobile client to a summary from the client regarding map data already stored at the mobile client so that the central server need only download the differences in the map data, if any, to the mobile client.

13. The system of claim 12, wherein the summary of map data present in the client is transmitted to the central server in a reduced-data format.

14. The system of claim 13, wherein the reduced-data format comprises designators associated with regions into which a map has been partitioned.

15. The system of claim 14, wherein the regions are tiles.

16. The system of claim 13, wherein the reduced data format comprises:
designators associated with tiles into which the map has been partitioned; and
offsets from said designator each of which said offsets uniquely specifies a tile.

17. The system of claim 16, wherein the offsets are represented by a data format less data-intensive than the format used to represent the designators.

18. The system of claim 13, wherein the reduced data format also includes representations of blocks of data.

19. The system of claim 18, wherein the blocks of data are represented in a format less data intensive than the format used to represent the designators.

20. The system of claim 12, wherein the server excludes data from being sent to the client based on one or more geographical criteria.

21. The method of claim 20, wherein the criteria includes a distance from a location or route.
